(19) United States
(12) Patent Application Publication
(10) Pub. No.: US 2011/0272936 A1
(43) Pub. Date: Nov. 10, 2011

(54) QUICK CONNECT COUPLING MECHANISM ADAPTER

(75) Inventor: Theron Tanner Mayhew, St. Joseph, MO (US)

(73) Assignee: VEKTEK, INC., Emporia, KS (US)

(21) Appl. No.: 12/941,684

(22) Filed: Nov. 8, 2010

Related U.S. Application Data
(60) Provisional application No. 61/259,308, filed on Nov. 9, 2009.

(51) Int. Cl. F16L 37/00

(52) U.S. Cl. 285/33

(57) ABSTRACT

An adapter for use with a quick connect coupling mechanism including a male member and a female member comprises a shroud, a base, and a trigger element. The shroud may be tubular in shape and may be placed on an outer sleeve of the female member. The base may be coupled to the rear edge of the shroud, extending rearward therefrom and may maintain linear motion of the adapter during usage. The trigger element may be coupled to the shroud and the base and may extend outward therefrom. The trigger element may include an arcuate forward wall that is configured to receive a finger of a user and to be pulled rearward during retraction of the outer sleeve.

### RELATED APPLICATION

This non-provisional patent application claims priority benefit with regard to all common subject matter of the earlier filed U.S. Provisional Patent Application titled “QUICK CONNECT COUPLING MECHANISM”, Ser. No. 61/259,308, filed on Nov. 9, 2009, which is hereby incorporated by reference in its entirety into the present application.

### BACKGROUND OF THE INVENTION

1. Field of the Invention

Embodiments of the present invention relate to coupling mechanisms. More particularly, embodiments of the present invention relate to adapters for quick connect coupling mechanisms.

2. Description of the Related Art

Coupling mechanisms are often used in fluid or gas transfer systems, such as hydraulic or pneumatic systems, to connect cables or hoses to each other or to other system components. To facilitate the coupling process, quick connect/disconnect couplers are used. A widely used version of the quick connect coupler comprises a male member, often attached to a system component, and a female member, often attached to a cable or hose. The male member may include a central axis tip with a circumferential groove. The female member may include a central axis opening and a telescopically slidable outer sleeve which is typically spring loaded to a forward position on the female member. The female member may further include at least one ball that rigidly protrudes into the opening in a locked state when the outer sleeve is in the forward position. The ball may recede from the opening into a recess when the sleeve is retracted and the ball is in an unlocked state.

The two members are coupled by retracting the outer sleeve to unlock the ball, pushing the female member onto the male member, and then releasing the outer sleeve to lock the ball into the male member groove. Generally, retracting the outer sleeve involves gripping the female member and a portion of the cable or hose between the palm and fingers while pulling the sleeve backward with the thumb and index finger. Since the outer sleeve is retracted at the same time as the female member is pushed forward—and in the opposite direction as the retracting motion—the coupling process with a quick connect coupler is tedious and awkward. And, if the process is performed often, it could can cause fatigue and lead to repetitive motion injuries.

### SUMMARY OF THE INVENTION

Embodiments of the present invention solve the above-mentioned problems and provide a distinct advance in the art of coupling mechanisms. More particularly, embodiments of the invention provide adapters for quick connect coupling mechanisms which allow a user to more easily connect the mechanisms.

Embodiments of the adapter are configured for use with a quick connect coupling mechanism including a male member and a female member. The adapter broadly comprises a shroud, a base, and a trigger element. The shroud may be tubular in shape and may be placed on an outer sleeve of the female member. The shroud may include a locking mechanism to prevent the shroud from sliding backward while on the outer sleeve. The base may be coupled to the rear edge of the shroud, extending rearward therefrom and may maintain linear motion of the adapter during usage. The trigger element may be coupled to the shroud and the base and may extend outward therefrom. The trigger element may include an arcuate forward wall that is configured to be engaged by a user's finger and to be pulled rearward during retraction of the outer sleeve. The shroud, the base, and the trigger element may be monolithically formed or formed separately and connected.

One embodiment of the adapter may also include a collar that fits over a rear fitting of the female member. An outer wall of the collar may be cylindrical in shape and slidably contacts the base during retraction of the outer sleeve.

Another embodiment of the adapter may also include a riser that couples to the upper surface of the base and slidably contacts the rear fitting of the female member during retraction of the outer sleeve.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a side sectional view of an adapter as constructed in accordance with at least one embodiment of the present invention for use with a quick connect coupling mechanism, of which a female member is shown;

FIG. 2 is an exploded view of the adapter of FIG. 1, depicting a shroud, a trigger element, a base, and a collar, along with the female member;

FIG. 3 is a side view of the quick connect coupling mechanism depicting a user coupling the female member to a male member without the use of the adapter of FIG. 1;

FIG. 4A is a side view depicting a first step of coupling the female member to the male member while using the adapter of FIG. 1;

FIG. 4B is a side view depicting a second step of coupling the female member to the male member while using the adapter of FIG. 1;

FIG. 5 is a side sectional view of another embodiment of the adapter along with the female member depicting retraction of an outer sleeve using the adapter;

FIG. 6 is a side sectional view of the adapter of FIG. 5 along with the female member depicting operation of the adapter without a collar or a riser; and

FIG. 7 is a front view of the adapter of either FIG. 1 or FIG. 5 showing the shroud, the trigger element, and a locking mechanism.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

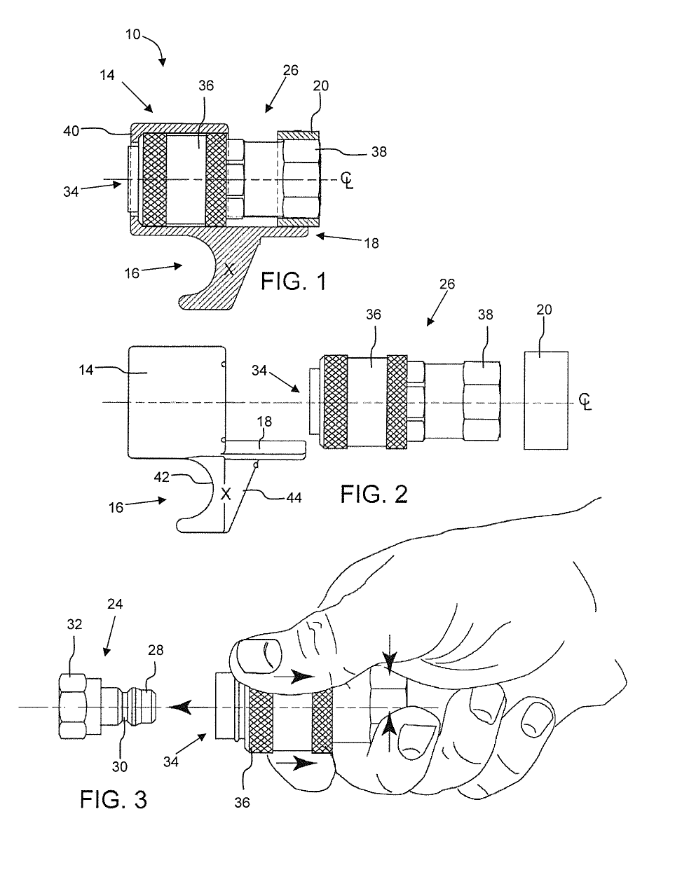

An adapter 10 constructed in accordance with various embodiments of the current invention for use with a quick connect coupling mechanism 12 is shown in FIGS. 1-2 and 4A-7. The adapter 10 may broadly comprise a shroud 14, a trigger element 16, and a base 18. The adapter 10 may further include a collar 20 in one embodiment and a riser 22 in another embodiment.

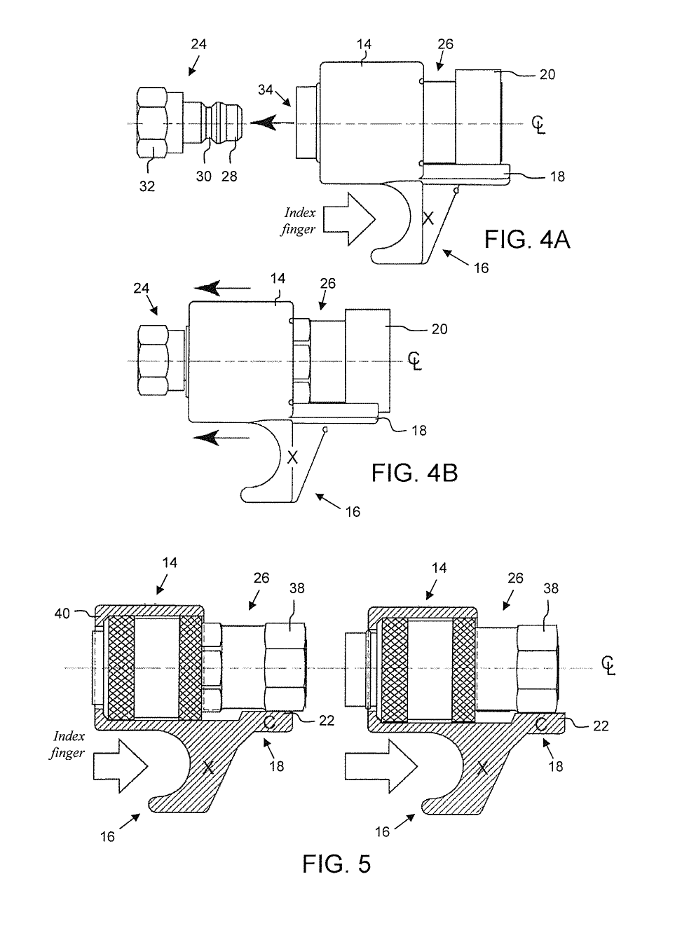

The quick connect coupling mechanism 12 may be commonly used in fluid or gas transfer systems, such as hydraulic or pneumatic systems, to connect cables or hoses to each other or to other system components. The quick connect coupling mechanism 12 may include a male member 24, seen in FIGS. 3-4, often attached to a system component (not shown) such as a work support or a clamp, and a female member 26, seen in FIGS. 1-6, that couples and decouples from the male member 24 and is often attached to a cable or hose (not shown).

The male member 24 may include a protruding central axis tip 28 with a circumferential groove 30. The male member 24 may also include a hexagonal rear fitting 32 on the opposite end of the male member 24 from the tip 28.

The female member 26 may include a central axis opening 34 and a telescopically slidable outer sleeve 36, which is typically spring loaded to a forward position on the female member 26. With regard to the female member 26 as well as the adapter 10, “forward” indicates proximal to or in a direction toward the opening 34, whereas “backward” or “rearward” indicates distal from or in a direction away from the opening 34. The female member 26 may further include at least one ball (not shown in the figures) that rigidly protrudes into the opening 34 in a locked state when the outer sleeve 36 is in the forward position. The ball may have a shape other than spherical, such as elliptical or roughly rectangular. The ball may recede from the opening 34 into a recess (not shown) of the female member 26 when the outer sleeve 36 is retracted and the ball is in an unlocked state. The female member 26 may have a general cylindrical shape and may also include a hexagonal rear fitting 38 on the distal end of the female member 26.

The shroud 14 of the adapter 10 is generally tubular in shape with an outer wall that is thick enough to provide mechanical strength without adding extra weight. The length of the shroud 14 may be approximately the same length as the outer sleeve 36, and the inner diameter of the shroud 14 may be slightly larger than the outer diameter of the outer sleeve 36. In usage, the shroud 14 is placed over the outer sleeve 36 with a snug fit such that the shroud 14 is held in place at least partly by friction being desirable.

The shroud 14 may include a locking mechanism 40, either radial or linear, to prevent the shroud 14 from sliding backward when the adapter 10 is in use. In various embodiments, the locking mechanism 40 may include an annular end wall, as seen in FIGS. 1 and 5-7, positioned at one end of the shroud 14 and extending inward from the outer circumference. The end wall engages the forward edge of the outer sleeve 36 when the shroud 14 is placed thereon. The inner diameter of the end wall is generally equal to, or slightly greater than, the inner diameter of the outer sleeve 36 so that the end wall does not contact any other part of the female member 26 when the outer sleeve is retracted. In other embodiments, the locking mechanism 40 may include a set screw that extends through the side wall of the shroud 14 and engages the outer sleeve 36.

The trigger element 16 may include a forward wall 42 and a rear wall 44 coupled thereto. The forward wall 42 may have a generally crescent or arc shape to receive a finger, typically an index finger, of a user. The forward wall 42 may couple to the shroud 14, generally along the outer surface toward the back half of the shroud 14. The rear wall 44 may be angled upward toward the rear in some embodiments, such as those shown in the figures. In other embodiments, the rear wall 44 may be substantially vertical. The trigger element 16 generally extends outward from both the shroud 14 and the base 18.

The base 18 may couple to the back edge of the shroud 14 and extend rearward therefrom. The base 18 may maintain linear motion of the adapter 10 while retracting the outer sleeve 36. The base 18 generally has the same thickness as the wall of the shroud 14. The length of the base 18 may be determined by the length of the female member 26, such that when the shroud 14 is placed over the outer sleeve 36, at least a portion of the base 18 overlaps the rear fitting 38 of the female member 26. The base 18 may also couple with the rear wall 44 of the trigger element 16, which helps to provide mechanical support for the base 18.

The collar 20, as seen in FIGS. 1-2 and 4A-4B, may present a ring shape with an outer wall that is generally cylindrical. In usage, the collar 20 is placed over the rear fitting 38 of the female member 26. Thus, the collar 20 may have an inner wall that has the same cross-sectional shape as the rear fitting 38, which in many cases, is hexagonal. Furthermore, the collar 20 has roughly the same length as the rear fitting 38, while the inner dimensions of the collar 20 are generally slightly larger than the outer dimensions of the fitting 38. In addition, the collar 20 has roughly the same outer diameter as the outer sleeve 36.

The riser 22, as seen in FIG. 5, may be positioned at the rear of the base 18 on the upper surface thereof. The riser 22 may function as an inward extension of the base 18 to contact the rear fitting 38 of the female member 26 in the absence of the collar 20. Therefore, the riser 22 may have a height that is equivalent to the distance between the upper surface of the base 18 and the rear fitting 38, which in some cases may be equivalent to the thickness of the outer sleeve 36.

The adapter 10 may be constructed from lightweight materials, such as plastics, although it is possible to construct the adapter 10 from metals or other rigid materials. In the embodiment of FIGS. 1-4, the shroud 14, the trigger element 16, and the base 18 may be monolithically formed as a single unit, while the collar 20 is a separate component. If constructed from plastic, the shroud 14, the trigger element 16, and the base 18 may be injection molded using a single mold. In the embodiment of FIG. 5, the shroud 14, the trigger element 16, the base 18, and the riser 22 may be monolithically formed as a single unit. If constructed from plastic, the shroud 14, the trigger element 16, the base 18, and the riser 22 may be injection molded using a single mold.

The quick connect coupling mechanism 12 without the adapter 10 may be coupled as depicted in FIG. 3 and described hereafter. The outer sleeve 36 is retracted by gripping the female member 26 and a portion of the cable or hose connected thereto between the palm and fingers while pulling the sleeve 36 backward with the thumb and index finger. Retraction of the outer sleeve 36 unlocks the ball. Then, the female member 26 is pushed onto the male member 24, such that the tip 28 aligns with the opening 34. When the female member 26 is moved onto the male member 24 as far as possible, the grip on the outer sleeve 36 may be released such that the spring-loaded sleeve 36 is urged forward, thereby locking the ball in the male member 24 groove 30.

The quick connect coupling mechanism 12 may be decoupled in a similar fashion. The outer sleeve 36 is retracted, unlocking the ball, while pulling the female member 26 away from the male member 24. Once the female member 26 is clear of the male member 24, the outer sleeve 36 may be released.

In practice, it may require some force from the user to oppose the force from the springs in the female member 26 in order to retract the outer sleeve 36. In addition, it may require some force from the user to push the female member 26 onto the male member 24 to align the ball with the groove 30. Furthermore, since retraction of the outer sleeve 36 requires pulling on the sleeve 36 while pushing the female member 26 in the opposite direction, the process of coupling the quick connect coupling mechanism 12 is tedious and cumbersome. The adapter 10 provides the advantage of allowing the user to retract the outer sleeve 36 by just pulling on the trigger element 16 with the index finger. This is a more comfortable position for the user and allows him to more easily push the female member 26 onto the male member 24, while retracting the outer sleeve 36. It is also possible for the user to pull the trigger element 16 with his thumb while holding the rear fitting 38 with his fingers. This orientation is generally used when the male member 24 is connected to the upper surface of a component such that the female member 26 is pushed downward onto the male member 24. Often, the adapter 10 is used in combination with a right-angle connector (not shown in the figures) that is coupled to the rear fitting 38 of the female member 26 to form a pistol-like grip, which further increases the ease of coupling the female member 26 with the male member 24.

The embodiment of the adapter 10 shown in FIGS. 1-4 may be integrated with the female member 26 by sliding the shroud 14 over the outer sleeve 36 until the forward edge of the sleeve 36 engages the locking mechanism 40. The collar 20 may be placed on the rear fitting 38 before any cables, hoses, or connectors are attached thereto. Generally, the upper surface of the base 18 slidably contacts some portion of the collar 20.

The quick connect coupling mechanism 12 that includes the embodiment of the adapter 10 shown in FIGS. 1-3 may be coupled as depicted in FIGS. 4A-4B and described hereafter. The user may place his index finger on the forward wall 42 of the trigger element 16 and pull backward to initiate retraction of the outer sleeve 36, as shown in FIG. 4A. The outer sleeve 36 may move rearward as the base 18 slides rearward with respect to the collar 20. With the outer sleeve 36 retracted and the ball unlocked, the female member 26 may be pushed onto the male member 24. Once the female member 26 is fully pushed onto the male member 24, the user may remove his finger, allowing the outer sleeve 36, the shroud 14, the trigger element 16, and the base 18 all to slide forward, thereby locking the ball into the groove 30.

The embodiment of the adapter 10 shown in FIG. 5 may be integrated with the female member 26 by sliding the shroud 14 over the outer sleeve 36 until the forward edge of the sleeve 36 engages the locking mechanism 40. The shroud 14 may have to be tilted slightly in order for the riser 22 to get past the outer sleeve 36. Generally, the riser 22 slidably contacts at least one face of the rear fitting 38.

Another embodiment of the adapter 10 may be used to retract the outer sleeve 36 as shown in FIG. 5. The user may place his index finger on the forward wall 42 of the trigger element 16 and pull backward. The outer sleeve 36 may move rearward as the base 18 and the riser 22 slide rearward with respect to the rear fitting 38. The rest of the coupling process may be substantially similar to that described above for the embodiment of the adapter 10 shown in FIGS. 1-4.

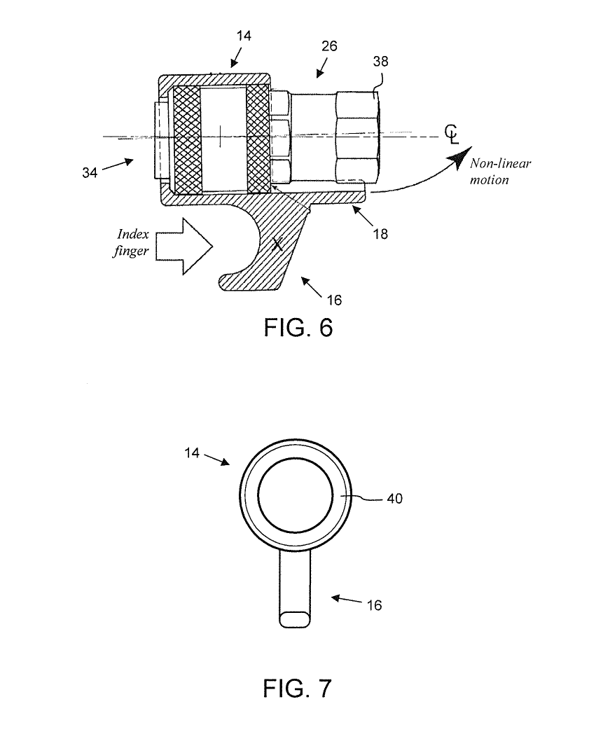

The collar 20 and the riser 22 both provide stability for the adapter 10 as the outer sleeve 36 is retracted by pulling rearward on the trigger element 16. Because of the collar 20 or the riser 22, the adapter 10 avoids rocking, wobbling, misalignment, or other errant, nonlinear motions, seen in FIG. 6, as the coupling or decoupling process is occurring.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. An adapter for use with a quick connect coupling mechanism including a male member and a female member, the adapter comprising:
a shroud configured to be placed on an outer sleeve of the female member;
a base coupled to the rear edge of the shroud and extending rearward therefrom, the base configured to maintain linear motion of the adapter during retraction of the outer sleeve; and
a trigger element coupled to the shroud and the base, the trigger element configured to be pulled rearward to initiate retraction of the outer sleeve.

2. The adapter of claim 1, further including a collar configured to be placed on a rear fitting of the female member to slidably contact the base.

3. The adapter of claim 1, further including a riser positioned on an upper surface of the base and configured to slidably contact a rear fitting of the female member.

4. The adapter of claim 3, wherein the shroud, the base, the trigger element, and the riser are monolithically formed.

5. The adapter of claim 1, wherein the shroud, the base, and the trigger element are monolithically formed.

6. The adapter of claim 1, wherein the trigger element includes an arcuate forward wall configured to be engaged by a user's finger.

7. The adapter of claim 1, wherein the shroud includes a locking mechanism configured to prevent the shroud from sliding backward when the adapter is in use.

8. The adapter of claim 7, wherein the locking mechanism includes an annular end wall configured to engage the forward edge of the outer sleeve.

9. The adapter of claim 1, wherein the shroud has a tubular shape.

10. The adapter of claim 1, wherein the trigger element extends outward from the shroud and the base.

11. An adapter for use with a quick connect coupling mechanism including a male member and a female member, the adapter comprising:
a shroud of tubular shape configured to be placed on an outer sleeve of the female member, the shroud including an annular end wall configured to engage the forward edge of the outer sleeve;
a base coupled to the rear edge of the shroud and extending rearward therefrom, the base configured to maintain linear motion of the adapter during retraction of the outer sleeve; and
a trigger element coupled to the shroud and the base and extending outward therefrom, the trigger element including an arcuate forward wall configured to be engaged by a user's finger and be pulled rearward to initiate retraction of the outer sleeve,
wherein the shroud, the base, and the trigger element are monolithically formed.

12. The adapter of claim 11, further including a collar configured to be placed on a rear fitting of the female member to slidably contact the base.

13. The adapter of claim 11, further including a riser positioned on an upper surface of the base and configured to slidably contact a rear fitting of the female member.

14. A quick connect coupling mechanism comprising:
a male member including a protruding central axis tip with a circumferential groove; and
a female member configured to detachably couple with the male member, the female member including—
an outer sleeve that is telescopically slidable and urged toward a forward position,
a rear fitting configured to couple the female member to other components,
a shroud of tubular shape and placed on the outer sleeve, the shroud including an annular end wall that engages the forward edge of the outer sleeve,
a base coupled to the rear edge of the shroud and extending rearward therefrom, the base configured to maintain linear motion of the shroud when the outer sleeve is moved to a rear position, and
a trigger element coupled to the shroud and the base and extending outward therefrom, the trigger element configured to be pulled rearward to move the outer sleeve to the rear position.

15. The quick connect coupling mechanism of claim 14, wherein the female member further includes a collar placed on the rear fitting to slidably contact the base.

16. The quick connect coupling mechanism of claim 14, wherein the female member further includes a riser positioned on an upper surface of the base to slidably contact the rear fitting.

17. The quick connect coupling mechanism of claim 14, wherein the trigger element includes an arcuate forward wall configured to receive a finger of a user.

18. The quick connect coupling mechanism of claim 14, wherein the shroud, the base, and the trigger element are monolithically formed.
